(19) United States
(12) Patent Application Publication
(10) Pub. No.: US 2011/0242011 A1
(43) Pub. Date: Oct. 6, 2011

(54) TOUCH INPUT DEVICE

(75) Inventors: Chun-Wei Wu, Chiayi City (TW); Yu-Ping Ho, Xindian City (TW); Cheng-Chung Hu, Padeh City (TW); Long-Cai Jhuo, Banqiao City (TW); Jyun-Cheng Lin, Zhongli City (TW)

(73) Assignee: CHUNGHWA PICTURE TUBES, LTD., Padeh City (TW)

(21) Appl. No.: 12/836,387

(22) Filed: Jul. 14, 2010

(30) Foreign Application Priority Data
Mar. 30, 2010 (TW) 099109622

(51) Int. Cl. G06F 3/041

(52) U.S. Cl. 345/173

(57) ABSTRACT

A touch input device includes a substrate and a plurality of touch-sensing strips. The substrate has a flat surface. The touch-sensing strips are all disposed side by side on the flat surface. Each touch-sensing strip includes a plurality of sensing electrodes electrically connected to one another in series. Each sensing electrode has a top surface, and the areas of the top surfaces in at least two sensing electrodes of each touch-sensing strip are not equal to each other.

### CROSS-REFERENCE TO RELATED APPLICATION

This application claims the benefit of Taiwan Patent Application No.099109622, filed on Mar. 30, 2010, which is hereby incorporated by reference for all purposes as if fully set forth herein.

### BACKGROUND OF THE INVENTION

1. Field of the Invention

The present invention relates to an input device, and more particularly to a touch input device.

2. Description of Related Art

Nowadays, many electronic devices, for example, handheld electronic devices such as mobile phones, personal digital assistants (PDAs), and global positioning system (GPS) navigation devices, and computers, etc., usually need to be operated by input devices such as keyboards, mice, and touch panels. Touch panels are widely used, and touch panels can be integrated with screens of electronic devices into touch-control type screens.

FIG. 1A is a top schematic view of a conventional touch panel, and FIG. 1B is a cross-sectional schematic view taken along line I-I of FIG. 1A. Please refer to FIG. 1A and FIG. 1B, a conventional touch panel 100 includes a transparent glass plate 110, a plurality of vertical conductive strips 120, a plurality of horizontal conductive strips 130, a chip 140, and a plurality of peripheral traces 150.

The transparent glass plate 110 has an upper surface 112 and a lower surface 114. The lower surface 114 is opposite to the upper surface 112. The vertical conductive strips 120 and the peripheral traces 150 are all disposed on the upper surface 112, and the horizontal conductive strips 130 are all disposed on the lower surface 114, as shown in FIG. 1B.

As described above, the vertical conductive strips 120 and the horizontal conductive strips 130 are both transparent indium tin oxide (ITO) films. The vertical conductive strips 120 and the horizontal conductive strips 130 have a plurality of conductive layers 122, 132 respectively. The conductive layers 122 in one of any vertical conductive strips 120 are electrically connected to one another. The conductive layers 132 in any one of horizontal conductive strips 130 are electrically connected to one another.

The peripheral traces 150 electrically connect to the chip 140, the vertical conductive strips 120 and the horizontal conductive strips 130, so that the chip 140 can be electrically connected to the vertical conductive strips 120 and the horizontal conductive strips 130 via the peripheral traces 150. When a stylus P1 touches the upper surface 112 or touches the conductive layers 122, the capacitance value caused by the vertical conductive strips 120 or the horizontal conductive articles 120 corresponding to the stylus P1 changes. The chip 140 will get the position information of the stylus P1 according to the changes of the capacitance value so as to control an electronic device, thereby enabling users to operate the electronic device via the touch panel 100.

In general, the more the number of both the vertical conductive strips 120 and the horizontal conductive strips 130 is, the better the accuracy of the touch panel 100 is. That is to say, the touch panel 100 can detect the position of the stylus P1 more accurately. However, a large number of vertical conductive strips 120 and horizontal conductive strips 130 also cause the great increase in the number of the peripheral traces 150, so that the transparent glass plate 110 must have a larger-area upper surface 112 to accommodate a large number of peripheral traces 150.

Currently, handheld electronic devices, computers and other electronic devices all become smaller and smaller in size. So the area of the transparent glass plate 110 must be reduced. However, since the touch-control type screen 100 requires a large number of peripheral traces 150 to maintain or improve the accuracy of the touch panel 100, the large number of peripheral traces 150 are disposed on the upper surface 112 of the transparent glass plate 110, and the area of the upper surface 112 of the transparent glass plate 110 cannot be reduced. It results in the conventional touch panel 100 being difficult to keep with the development trend of electronic devices towards small size.

### SUMMARY OF THE INVENTION

An object of the present invention is to provide a touch input device which can reduce the number of required peripheral traces.

The present invention provides a touch input device. The touch input device includes a substrate and a plurality of touch-sensing strips. The substrate has a flat surface. The touch-sensing strips are all disposed side by side on the flat surface. Each touch-sensing strip includes a plurality of sensing electrodes electrically connected to one another in series. Each sensing electrode has a top surface, and the areas of the top surfaces in at least two sensing electrodes of each touch-sensing strip are not equal to each other.

Based on the above, since the areas of the top surfaces in at least two sensing electrodes of each touch-sensing strip are different from each other, the capacitance values generated by the sensing electrodes of the same touch-sensing strip are different from each other. When a stylus or a finger touches the touch input device of the present invention, according to the above capacitance values, the present invention can not only determine the position of the stylus or the finger, but also reduce the number of peripheral traces while maintaining or improving the accuracy, thereby keeping with the development trend of electronic devices towards small size.

To further understand the above features and advantages of the present invention clearly, please refer to the following detailed description and drawings of embodiments of the present invention.

### BRIEF DESCRIPTION OF THE DRAWINGS

FIG. 1A is a top schematic view of a conventional touch panel;

FIG. 1B is a cross-sectional schematic view taken along line I-I of FIG. 1A;

FIG. 2A is a top schematic view of an embodiment of a touch input device according to the present invention; and

FIG. 2B is a cross-sectional schematic view taken along line J-J of FIG. 2A.

### DETAILED DESCRIPTION OF THE EMBODIMENTS

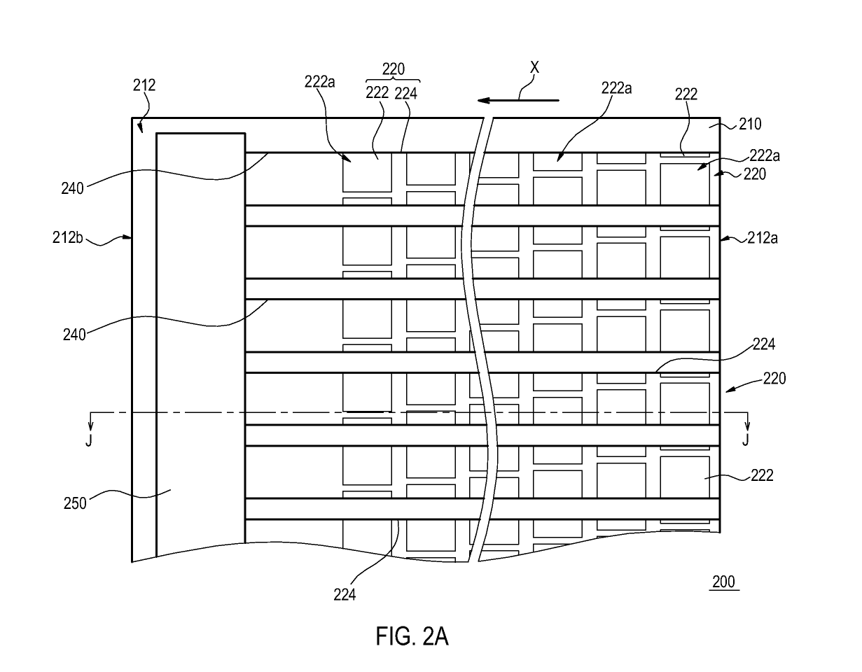

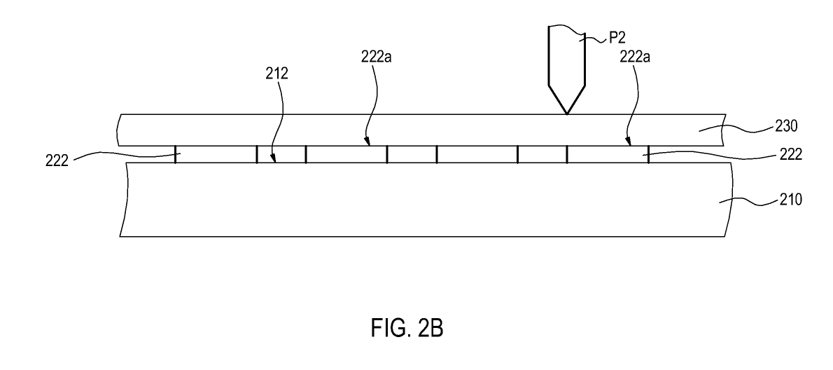

FIG. 2A is a top schematic view of an embodiment of a touch input device according to the present invention and FIG. 2B is a cross-sectional schematic view taken along line J-J of FIG. 2A. Please refer to FIG. 2A and FIG. 2B, a touch input device 200 in the embodiment can be used for operating an electronic device. The touch input device 200 may be a touch panel which can be integrated into touch-control type screens with screens of a variety of electronic devices. The touch input device 200 may also be a touchpad (also called “trackpad”).

The electronic device may be a handheld electronic device such as a mobile phone, a PDA, a GPS navigation device, a digital audio player (DAP, for example, a MP3 player), and a handheld game console; or a computer such as a desktop computer, a laptop, an industrial computer and an Ultra-Mobile PC (UMPC); or an automatic teller machine (ATM), a point of sale machine (POS), an arcade machine and so on.

The touch input device 200 includes a substrate 210 and a plurality of touch-sensing strips 220. The substrate 210 has a flat surface 212. The touch-sensing strips 220 are disposed side by side on the flat surface 212. When the touch input device 200 is a touch panel, the substrate 210 may be a transparent plate, and the material of the transparent plate includes a transparent material such as glass. When the touch input device 200 is a touchpad, the substrate 210 may be an opaque plate, and the substrate 210 and the touch-sensing strips 220 may be integrated into a printed circuit board (PCB). Therefore, the substrate 210 is not necessarily transparent.

As described above, the touch-sensing strips 220 all extend in a direction X. Specifically speaking, the flat surface 212 of the substrate 210 has a first side edge 212a and a second side edge 212b opposite to each other. The direction X points from the first side edge 212a to the second side edge 212b. Therefore, the touch-sensing strips 220 all extend from the first side edge 212a towards the second side edge 212b.

Each touch-sensing strip 220 includes a plurality of sensing electrodes 222 and a plurality of connecting lines 224. The sensing electrodes 222 of each touch-sensing strip 220 are arranged in a row in the direction X, that is to say, the sensing electrodes 222 are arranged in a row along the extending direction of the touch-sensing strips 220. Each connecting lines 224 is electrically connected between two adjacent sensing electrodes 222, thereby the sensing electrodes 222 of the same touch-sensing strip 220 are electrically connected to one another in series. In addition, the connecting lines 224 may be a plurality of metal wires or a plurality of transparent conductive wires. The material of the transparent conductive wires may include indium tin oxide (ITO) or indium zinc oxide (IZO).

Each sensing electrode 222 has a top surface 222a, and the areas of at least two top surfaces 222a in each touch-sensing strip 220 are not equal to each other. The so-called “not equal” herein means: when observing the sensing electrodes 222 directly by the naked eye or by an optical microscope, a person can clearly see that the areas of at least two top surfaces 222a in the same touch-sensing strip 220 are not equal to each other. In other words, seen from the appearance, the areas of at least two top surfaces 222a are distinctly different from each other.

In the embodiment shown in FIG. 2A, the areas of the top surfaces 222a in one touch-sensing strip 220 increase by degrees from the first side edge 212a to the second side edge 212b (for example, the top touch-sensing strip 220 shown in FIG. 2A), while the areas of the top surfaces 222a in another touch-sensing strip 220 decrease by degrees from the first side edge 212a to the second side edge 212b (for example, the second touch-sensing strip 220 from the top in FIG. 2A).

The total area of any two top surfaces 222a in each touch-sensing strip 220 is not equal to that of other two top surfaces 222a in the same touch-sensing strips 220. Moreover, although the shapes of the top surfaces 222a shown in FIG. 2A are all rectangles, they may also be circles, diamonds, triangles and so on. Therefore, the present invention is not limited to the shapes of the top surfaces 222a shown in FIG. 2A.

In the embodiment, the sensing electrodes 222 may be a plurality of metal films or a plurality of transparent conductive films. The material of the transparent conductive film may include indium tin oxide or indium zinc oxide. Specifically speaking, when the touch input device 200 is a touch panel and the substrate 210 is a transparent plate, the sensing electrodes 222 may be transparent conductive films. When the touch input device 200 is a touchpad and the substrate 210 is an opaque plate, the sensing electrodes 222 may be metal films.

The touch input device 200 may further include a protective layer 230 which is disposed on the flat surface 212 and covers the touch-sensing strips 220. Therefore, the protective layer 230 can protect the touch-sensing strips 220 from a scratch. In addition, the protective layer 230 may be transparent and an insulator. For example, the material of the protection layer 230 is glass or a polymer material such as PMMA (Polymethylmethacrylate). Therefore, not only the touch input device 200 can be applied in a touch-control type screen, but also the touch-sensing strips 220 would not cause a short circuit due to the protective layer 30.

The touch input device 200 may further include a plurality of peripheral traces 240 and a chip 250. The peripheral traces 240 and the chip 250 are all disposed on the flat surface 212. These peripheral traces 240 are disposed between the chip 250 and the touch-sensing strips 220, and electrically connected to the touch-sensing strips 220 respectively. The chip 250 is electrically connected to all of the peripheral traces 240, that is to say, the peripheral traces 240 are electrically connected between the chip 250 and the touch-sensing strips 220.

The touch input device 200 can be operated by a stylus P2 (as shown in FIG. 2B) or a finger, wherein the stylus P2 may be a capacitive stylus. When the stylus P2 or the finger touches the touch input device 200, the sensing electrode 222 corresponding to the stylus P2 or the finger will generate a capacitance value. According to the capacitance value, the chip 250 can determine the position of the stylus P2 or the finger on the flat surface 212, so that users can operate electronic devices such as computers or handheld electronic devices.

The area of the top surface 222a in each sensing electrode 222 is generally smaller than the area of the flat surface 212 occupied by the stylus P2 or the finger. Thus, when touching the touch input device 200, the stylus P2 or the finger will completely cover at least one sensing electrode 222 to generate the above capacitance value. According to the basic electrical principles, the capacitance value is proportional to the area of the top surface 222a, that is, the larger the area of the top surface 222a corresponding to the stylus P2 or the finger is, the greater the capacitance value is; and on the contrary, the smaller the area of the top surface 222a corresponding to the stylus P2 or the finger is, the smaller the capacitance value is.

Since the respective areas of at least two top surfaces 222a in each touch-sensing strip 220 are not equal, the capacitance values generated by the touch electrodes 222a of the same touch-sensing strip 220 are different from each other, that is to say, the capacitance values, corresponding to the sensing electrodes 222, are different from each other. The chip 250 can find out the sensing electrode 222 corresponding to the stylus P2 or the finger and then determine the position of the stylus P2 or the finger based on the different capacitance values of the sensing electrodes 222.

In addition, the total area of any two top surfaces 222a in each touch-sensing strip 220 is not equal to that of other two top surfaces 222a in the same touch-sensing strip 220, therefore, even if at least two styluses P2 or at least two fingers touch the touch input device 200 and correspond to the same touch-sensing strip 220, the chip 250 can still identify the position of the two styluses P2 or the two fingers. Thus, the touch input device 200 may also be applied to an input interface for multi-point touch, such as a virtual keyboard.

As described above, because the respective areas of the top surfaces in at least two sensing electrodes of each touch-sensing strip are not equal to each other, the capacitance values of the sensing electrodes of the same touch-sensing strip are different from each other. According to the different capacitance values from the touch-sensing strips, the touch input device of the present invention can determine the position of the stylus or the finger, and then control the electronic device.

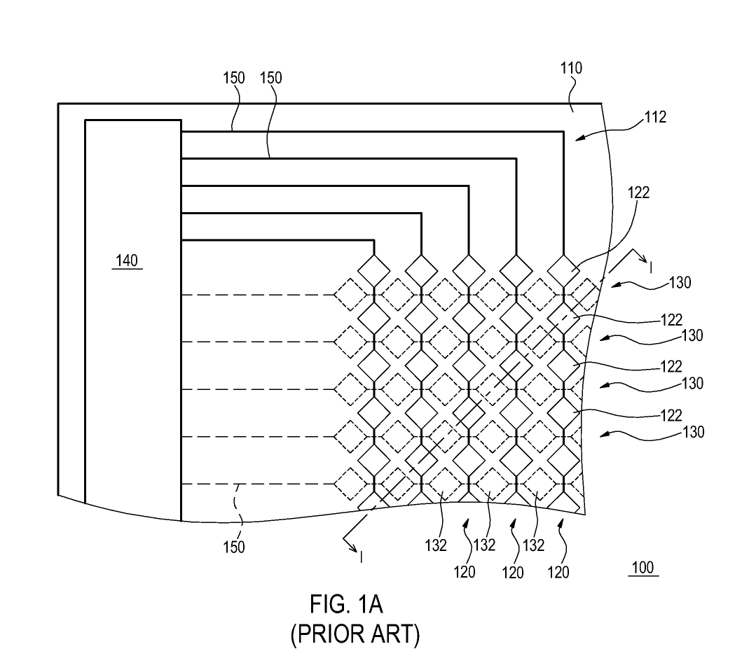

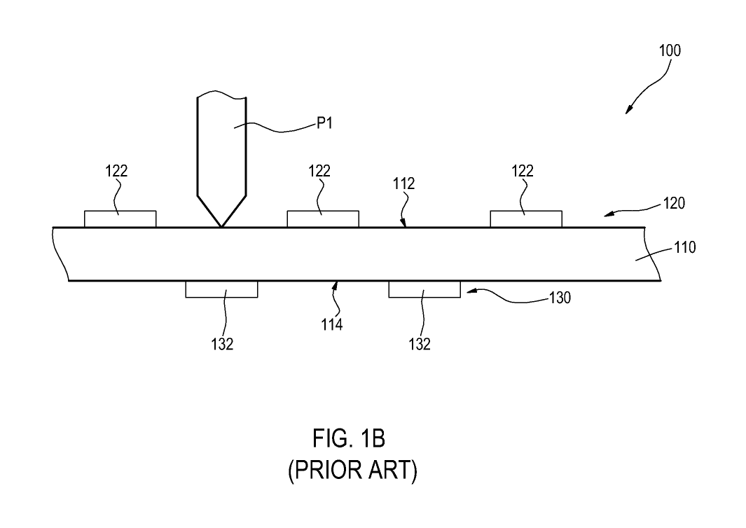

In addition, compared with conventional input devices, based on the above different capacitance values, the present invention may only use touch-sensing strips extending in a single direction without the need for two kinds of the touch-sensing strips extending in different directions (the vertical conductive strips 120 and the horizontal conductive strips 130 as shown in FIG. 1A). Thus, the present invention can reduce the number of the peripheral traces while maintaining or improving the accuracy, so that the area of the substrate can be reduced, thereby keeping with the development trend of electronic devices towards small size.

Furthermore, in one embodiment of the present invention, the total area of the top surfaces in any two sensing electrodes of each touch-sensing strip is not equal to that of the top surfaces in other two sensing electrodes of the same touch-sensing strip. Therefore, even if at least two styluses or at least two fingers correspond to the same touch-sensing strip, the present invention can still accurately identify the position of these styluses or fingers and furthermore prevent the generation of a ghost point. Hence, users can successfully operate electronic devices via the touch input device of the present invention.

What are disclosed above are only the specification and the drawings of the embodiment of the present invention and it is therefore not intended that the present invention be limited to the particular embodiment disclosed. It will be understood by those skilled in the art that various equivalent changes may be made depending on the specification and the drawings of the present invention without departing from the scope of the present invention.

What is claimed is:

1. A touch input device, comprising:
a substrate, having a flat surface; and
a plurality of touch-sensing strips, all disposed side by side on the flat surface, each touch-sensing strip including a plurality of sensing electrodes electrically connected to one another in series, wherein each sensing electrode has a top surface and an areas of the top surfaces in at least two sensing electrodes of each touch-sensing strip are not equal to each other.

2. The touch input device as claimed in claim 1, wherein a total area of any two top surfaces of each touch-sensing strip is not equal to a total area of other two top surfaces of the same touch-sensing strip.

3. The touch input device as claimed in claim 1, wherein the touch-sensing strips all extend in a direction and the sensing electrodes of each sensing strip are arranged in a row in the direction.

4. The touch input device as claimed in claim 1, wherein the flat surface has a first side edge and a second side edge opposite to each other; the touch-sensing strips extend from the first side edge towards the second side edge, and the areas of the top surfaces in one of the touch-sensing strips increase by degrees from the first side edge to the second side edge.

5. The touch input device as claimed in claim 4, wherein the areas of the top surfaces in another of the touch-sensing strips decrease by degrees from the first side edge to the second side edge.

6. The touch input device as claimed in claim 1, wherein the sensing electrodes are at least one metal film or at least one transparent conductive film.

7. The touch input device as claimed in claim 6, wherein a material of the transparent conductive film includes indium tin oxide or indium zinc oxide.

8. The touch input device as claimed in claim 1, wherein the substrate and the touch-sensing strips are integrated into a printed circuit board.

9. The touch input device as claimed in claim 1, wherein each touch-sensing strip further includes at least one connecting line electrically connected between two adjacent sensing electrodes.

10. The touch input device as claimed in claim 9, wherein the connecting line is a metal wire or a transparent conductive wire.

11. The touch input device as claimed in claim 10, wherein a material of the transparent conductive wire includes indium tin oxide or indium zinc oxide.

12. The touch input device as claimed in claim 1, further comprising a plurality of peripheral traces all disposed on the flat surface and respectively electrically connected to the touch-sensing strips.

13. The touch input device as claimed in claim 12, further comprising a chip disposed on the flat surface, wherein the peripheral traces are electrically connected between the chip and the touch-sensing strips.

14. The touch input device as claimed in claim 13, wherein the peripheral traces are disposed between the chip and the touch-sensing strips.

15. The touch input device as claimed in claim 1, further comprising a protective layer disposed on the flat surface and covering the touch-sensing strips.

16. The touch input device as claimed in claim 15, wherein the protective layer is transparent.

17. The touch input device as claimed in claim 1, wherein the substrate is a transparent plate.

18. The touch input device as claimed in claim 17, wherein a material of the transparent plate includes glass.
